(19) United States
(12) Patent Application Publication
(10) Pub. No.: US 2026/0257681 A1
(43) Pub. Date: Sep. 3, 2026

(54) VEHICLE DRIVING ASSISTANCE APPARATUS

(71) Applicant: TOYOTA JIDOSHA KABUSHIKI KAISHA, Toyota-shi (JP)

(72) Inventor: Hirotada OTAKE, Susono-shi (JP)

(73) Assignee: TOYOTA JIDOSHA KABUSHIKI KAISHA, Toyota-shi (JP)

(21) Appl. No.: 19/551,792

(22) Filed: Feb. 27, 2026

(30) Foreign Application Priority Data
Feb. 28, 2025 (JP) 2025-031294

(51) Int. Cl. B60W 30/18; B60W 30/14; B60W 50/00; B60W 60/00

(52) U.S. Cl. CPC B60W 30/18072; B60W 30/146; B60W 50/0097; B60W 60/001; B60W 2520/10; B60W 2552/05; B60W 2554/802

(57) ABSTRACT

A vehicle driving assistance apparatus executes an autonomous traveling control of autonomously driving a host vehicle while alternately switching between a power running control of causing the host vehicle to perform power running and a coasting control of causing the host vehicle to perform coasting. The vehicle driving assistance apparatus switches between the power running control and the coasting control such that a traveling speed of the host vehicle falls within a speed of a predetermined range or an inter-vehicle distance between the host vehicle and a preceding vehicle falls within a distance of a predetermined range, and narrows the predetermined range when a road on which the host vehicle is traveling is an ordinary road as compared with when the road on which the host vehicle is traveling is an expressway or a highway.

### CROSS-REFERENCE TO RELATED APPLICATIONS

This application claims priority to Japanese patent application No. JP 2025-031294 filed on February 28, 2025, the content of which is hereby incorporated by reference in its entirety.

### BACKGROUND

### Field

The present invention relates to a vehicle driving assistance apparatus.

### DESCRIPTION OF THE RELATED ART

There is known a vehicle driving assistance apparatus which executes an autonomous traveling control of autonomously driving a host vehicle by causing the host vehicle to perform power running or coasting. As such a conventional vehicle driving assistance apparatus, there is also known a vehicle driving assistance apparatus which prohibits coasting of the host vehicle by the autonomous traveling control when the host vehicle runs on a curve road or runs on an ordinary road (for example, see Japanese Unexamined Patent Application Publication No. 2018-122818). That is, there is known a vehicle driving assistance apparatus which prohibits coasting of the host vehicle by the autonomous traveling control in a situation where it is determined that a danger may occur by causing the host vehicle to coast.

As described above, in the conventional vehicle driving assistance apparatus, when the host vehicle is travelling on an ordinary road, since coasting of the host vehicle by the autonomous traveling control may cause a danger, such coasting is prohibited. However, even when the host vehicle is traveling on an ordinary road, it is not always the case that a danger occurs when coasting of the host vehicle by the autonomous traveling control is performed. That is, even if the host vehicle is traveling on an ordinary road, there is no need to prohibit coasting of the host vehicle by the autonomous traveling control. Under such circumstances, when coasting of the host vehicle is prohibited, an opportunity to reduce the energy used to run the host vehicle is lost.

### SUMMARY

An object of the present invention is to provide a vehicle driving assistance apparatus capable of appropriately causing the host vehicle to coast when the host vehicle is traveling on an ordinary road.

A vehicle driving assistance apparatus according to the present invention comprises an electronic control unit which executes an autonomous traveling control of autonomously driving a host vehicle while alternately switching between a power running control of causing the host vehicle to perform power running and a coasting control of causing the host vehicle to perform coasting. The electronic control unit is configured to switch between the power running control and the coasting control such that a traveling speed of the host vehicle falls within a speed of a predetermined range or an inter-vehicle distance between the host vehicle and a preceding vehicle falls within a distance of a predetermined range. Further, the electronic control unit is configured to narrow the predetermined range when a road on which the host vehicle is traveling is an ordinary road as compared with when the road on which the host vehicle is traveling is an expressway or a highway.

According to the present invention, when the host vehicle is traveling on an ordinary road, the predetermined range is made relatively narrow. Therefore, when the host vehicle is caused to coast by the autonomous traveling control, it is suppressed that the traveling speed of the host vehicle becomes excessively low or that the increase or decrease of the traveling speed of the host vehicle becomes excessively large. For this reason, when the host vehicle is traveling on an ordinary road, the host vehicle can be appropriately caused to coast.

In the vehicle driving assistance apparatus according to an aspect of the present invention, the electronic control unit may be configured to avoid executing the coasting control when a deceleration rate of the host vehicle by the coasting control is greater than a predetermined deceleration rate threshold.

When the deceleration rate of the host vehicle is large, there is a possibility that it causes trouble to drivers of other vehicles such as a following vehicle existing around the host vehicle. According to the present invention, when the deceleration rate of the host vehicle is greater than the predetermined deceleration threshold, the coasting control is not executed. Therefore, it is possible to suppress that the host vehicle causes trouble to drivers of other vehicles.

Further, when the deceleration rate of the host vehicle is large, after the start of the coasting control, the traveling speed of the host vehicle reaches a lower limit value of the predetermined range in a short time, or the inter-vehicle distance between the host vehicle and a preceding vehicle reaches an upper limit value of the predetermined range, and the coasting control immediately switches to the power running control. As a result, the effect of improving the energy efficiency related to the travel of the host vehicle decreases. Further, the ride comfort also deteriorates. According to the present invention, when the deceleration rate of the host vehicle is greater than the predetermined deceleration rate threshold, the coasting control is not executed. Therefore, it is possible to maintain the effect of improving the energy efficiency related to the travel of the host vehicle as a whole and suppress deterioration of the ride comfort.

Further, in the vehicle driving assistance apparatus according to another aspect of the present invention, the electronic control unit may be configured to set the predetermined deceleration rate threshold to a smaller value when a road on which the host vehicle is traveling is the ordinary road as compared with when the road on which the host vehicle is traveling is the expressway or the highway.

When the deceleration rate of the host vehicle is large while the host vehicle is traveling on an ordinary road, the possibility increases that trouble is caused to drivers of other vehicles such as a following vehicle existing around the host vehicle. According to the present invention, when the host vehicle is traveling on an ordinary road, the predetermined deceleration rate threshold is made small. Therefore, when the host vehicle is traveling on an ordinary road, it is possible to suppress that the host vehicle causes trouble to drivers of other vehicles.

Further, when the host vehicle is traveling on an ordinary road, generally, the traveling speed of the host vehicle is relatively low. Therefore, the deceleration rate of the host vehicle by execution of the coasting control is relatively small. However, even if the deceleration rate of the host vehicle by execution of the coasting control is relatively small when the host vehicle is traveling on an ordinary road, after the start of the coasting control, the traveling speed of the host vehicle reaches a lower limit value of the predetermined range in a short time, or the inter-vehicle distance between the host vehicle and a preceding vehicle reaches an upper limit value of the predetermined range, and the coasting control immediately switches to the power running control. As a result, the effect of improving the energy efficiency related to the travel of the host vehicle decreases. Further, the ride comfort also deteriorates. According to the present invention, when the host vehicle is traveling on an ordinary road, the predetermined deceleration rate threshold is made small. Therefore, when the host vehicle is traveling on an ordinary road, even if the deceleration rate of the host vehicle is relatively large, the coasting control is not executed. Therefore, it is possible to maintain the effect of improving the energy efficiency related to the travel of the host vehicle as a whole and suppress deterioration of the ride comfort.

Furthermore, in the vehicle driving assistance apparatus according to further another aspect of the present invention, the electronic control unit may be configured to predict a deceleration rate of the host vehicle in a case where the power running control being executed is switched to the coasting control, set the predetermined deceleration rate threshold to a smaller value when the road on which the host vehicle is traveling is the ordinary road as compared with when the road on which the host vehicle is traveling is the expressway or the highway, permit switching the power running control to the coasting control when the predicted deceleration rate is equal to or smaller than the predetermined deceleration rate threshold, and prohibit switching the power running control to the coasting control when the predicted deceleration rate is greater than the predetermined deceleration rate threshold.

According to the present invention, when the coasting control is not executed, the deceleration rate of the host vehicle in a case where the coasting control is executed is predicted, and whether to prohibit execution of the coasting control is determined based on the predicted deceleration. Therefore, it is possible to more appropriately suppress that the host vehicle causes trouble to drivers of other vehicles when the host vehicle is traveling on an ordinary road.

Further, as described above, when the host vehicle is traveling on an ordinary road, generally, the traveling speed of the host vehicle is relatively low. Therefore, the deceleration rate of the host vehicle by execution of the coasting control is relatively small. However, even if the deceleration rate of the host vehicle by execution of the coasting control is relatively small when the host vehicle is traveling on an ordinary road, after the start of the coasting control, the traveling speed of the host vehicle reaches a lower limit value of the predetermined range in a short time, or the inter-vehicle distance between the host vehicle and a preceding vehicle reaches an upper limit value of the predetermined range, and the coasting control immediately switches to the power running control. As a result, the effect of improving the energy efficiency related to the travel of the host vehicle decreases. Further, the ride comfort also deteriorates. According to the present invention, when the host vehicle is traveling on an ordinary road, compared with when the host vehicle is traveling on an expressway or a highway, the predetermined deceleration rate threshold is made small. Therefore, when the host vehicle is traveling on an ordinary road and the deceleration rate of the host vehicle is relatively large, the coasting control is not executed. Therefore, it is possible to maintain the effect of improving the energy efficiency related to the travel of the host vehicle as a whole and suppress deterioration of the ride comfort.

Furthermore, in the vehicle driving assistance apparatus according to further another aspect of the present invention, the electronic control unit is configured to set the predetermined deceleration rate threshold to a smaller value when the road on which the host vehicle is traveling is the ordinary road as compared with when the road on which the host vehicle is traveling is the expressway or the highway, and stop the coasting control when a deceleration rate of the host vehicle becomes greater than the predetermined deceleration rate threshold during execution of the coasting control.

According to the present invention, when the coasting control is being executed, the deceleration rate of the host vehicle in a case where the coasting control is started is predicted, and whether to prohibit execution of the coasting control is determined based on the predicted deceleration. Therefore, it is possible to more appropriately suppress that the host vehicle causes trouble to drivers of other vehicles when the host vehicle is traveling on an ordinary road.

Further, as described above, when the host vehicle is traveling on an ordinary road, generally, the traveling speed of the host vehicle is relatively low. Therefore, the deceleration rate of the host vehicle by execution of the coasting control is relatively small. However, even if the deceleration rate of the host vehicle by execution of the coasting control is relatively small when the host vehicle is traveling on an ordinary road, after the start of the coasting control, the traveling speed of the host vehicle reaches a lower limit value of the predetermined range in a short time, or the inter-vehicle distance between the host vehicle and a preceding vehicle reaches an upper limit value of the predetermined range, and the coasting control immediately switches to the power running control. As a result, the effect of improving the energy efficiency related to the travel of the host vehicle decreases. Further, the ride comfort also deteriorates. According to the present invention, when the host vehicle is traveling on an ordinary road, compared with when the host vehicle is traveling on an expressway or a highway, the predetermined deceleration rate threshold is made small. Therefore, when the host vehicle is traveling on an ordinary road and the deceleration rate of the host vehicle is relatively large, the coasting control is not executed. Therefore, it is possible to maintain the effect of improving the energy efficiency related to the travel of the host vehicle as a whole and suppress deterioration of the ride comfort.

The constituent elements of the present invention are not limited to the embodiments of the present invention described below with reference to the drawings. Other objects, other features, and incidental advantages of the present invention will be easily understood from the description of the embodiments of the present invention.

### BRIEF DESCRIPTION OF THE DRAWINGS

FIG. 1 is a diagram showing a vehicle driving assistance apparatus according to an embodiment of the present invention.

FIG. 2 is a diagram showing a preceding vehicle.

FIG. 3 is a flowchart showing a routine executed by the vehicle driving assistance apparatus according to the embodiment of the present invention.

FIG. 4 is a flowchart showing a routine executed by the vehicle driving assistance apparatus according to the embodiment of the present invention.

### DETAILED DESCRIPTION

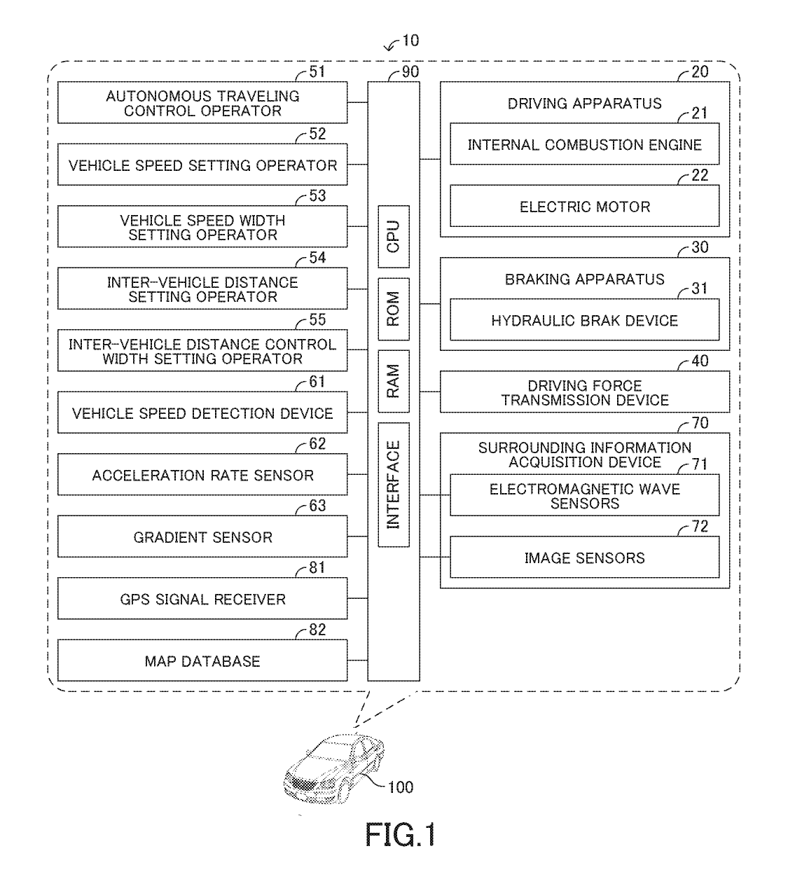

Hereinafter, a vehicle driving assistance apparatus according to an embodiment of the present invention will be described with reference to the drawings. In FIG. 1, the vehicle driving assistance apparatus 10 according to the embodiment of the present invention is shown. The vehicle driving assistance apparatus 10 is mounted on a host vehicle 100. Hereinafter, the vehicle driving assistance apparatus 10 will be described by taking, as an example, a case where an operator or a user of the host vehicle 100 is a driver of the host vehicle 100 (that is, a person who gets in the host vehicle 100 and drives the host vehicle 100). However, the operator or the user of the host vehicle 100 may be a remote operator of the host vehicle 100 (that is, a person who does not get in the host vehicle 100 and drives the host vehicle 100 remotely). It should be noted that, in the following description, the driver of the host vehicle 100 may be simply referred to as “driver.”

As shown in FIG. 1, the vehicle driving assistance apparatus 10 includes an ECU (electronic control unit) 90 as a control device. The ECU 90 includes a microcomputer as a main part. The microcomputer includes a CPU, a computer-readable storage medium, an interface, etc. The storage medium is ROM, RAM, nonvolatile memory, etc. The CPU is configured to realize various functions by executing instructions or programs or routines stored in the storage medium. In particular, in this embodiment, the vehicle driving assistance apparatus 10 stores, in the storage medium, programs for realizing various controls executed by the vehicle driving assistance apparatus 10.

It should be noted that, in this embodiment, the vehicle driving assistance apparatus 10 includes only one ECU 90, but the vehicle driving assistance apparatus 10 may be configured to include a plurality of ECUs and to have functions of the vehicle driving assistance apparatus 10 described below shared among the respective ECUs.

Further, the vehicle driving assistance apparatus 10 may be configured to be able to update (upgrade) programs stored in the storage medium by wireless communication (for example, Internet communication) with external devices.

Further, the vehicle driving assistance apparatus 10 can be applied not only to a vehicle that is driven by manual driving by an operator but also to a vehicle that is driven by automatic driving.

As shown in FIG. 1, the host vehicle 100 is equipped with a driving apparatus 20, a braking apparatus 30, and a driving force transmission device 40.

The driving apparatus 20 generates a driving force applied to the host vehicle 100 (in particular, driven wheels of the host vehicle 100). In this embodiment, the driving apparatus 20 includes an internal combustion engine 21 and at least one electric motor 22. The driving apparatus 20 is electrically connected to the ECU 90. The vehicle driving assistance apparatus 10 controls the driving force applied to the host vehicle 100 by controlling operation of the driving apparatus 20 (that is, the internal combustion engine 21 and the electric motor 22).

The braking apparatus 30 applies a braking force to the host vehicle 100 (in particular, wheels of the host vehicle 100). In this embodiment, the braking apparatus 30 includes a hydraulic brake device 31. The braking apparatus 30 is electrically connected to the ECU 90. The vehicle driving assistance apparatus 10 controls the braking force applied to the host vehicle 100 by controlling operation of the braking apparatus 30 (more specifically, operation of the hydraulic brake device 31).

The driving force transmission device 40 transmits the driving force output from the driving apparatus 20 to the driven wheels of the host vehicle 100. The driving force transmission device 40 is, for example, a transmission. The driving force transmission device 40 is electrically connected to the ECU 90. The vehicle driving assistance apparatus 10 establishes a driving force transmission path to transmit the driving force output from the driving apparatus 20 to the driven wheels of the host vehicle 100 by controlling operation of the driving force transmission device 40. The driving force transmission path transmits the driving force from the driving apparatus 20 to the driven wheels of the host vehicle 100. Also, the vehicle driving assistance apparatus 10 cuts off the driving force transmission path such that the driving force from the driving apparatus 20 is not transmitted to the driven wheels of the host vehicle 100 by controlling operation of the driving force transmission device 40.

Further, the host vehicle 100 is equipped with an autonomous traveling control operator 51, a vehicle speed setting operator 52, a vehicle speed control width setting operator 53, an inter-vehicle distance setting operator 54, an inter-vehicle distance control width setting operator 55, a vehicle speed detection device 61, an acceleration rate sensor 62, a gradient sensor 63, a surrounding information acquisition device 70, a GPS signal receiver 81, and a map database 82.

The autonomous traveling control operator 51 is operated by the driver. The driver requests execution of the autonomous traveling control described later or requests stopping thereof by operating the autonomous traveling control operator 51. The autonomous traveling control operator 51 is electrically connected to the ECU 90. The vehicle driving assistance apparatus 10 determines that execution of the autonomous traveling control is requested when the autonomous traveling control operator 51 is operated while the autonomous traveling control is not being executed. On the other hand, the vehicle driving assistance apparatus 10 determines that stopping of the autonomous traveling control is requested when the autonomous traveling control operator 51 is operated while the autonomous traveling control is being executed.

The vehicle speed setting operator 52 is operated by the driver. The driver sets a set vehicle speed Vset used for the autonomous traveling control described later by operating the vehicle speed setting operator 52. The set vehicle speed Vset is set by the driver as a target value of a host vehicle speed V1. The host vehicle speed V1 is a traveling speed of the host vehicle 100.

The vehicle speed control width setting operator 53 is operated by the driver. The driver sets a set vehicle speed control width WVset by operating the vehicle speed control width setting operator 53. The set vehicle speed control width WVset is used to set a target vehicle speed control width WVtgt used for the autonomous traveling control described later.

The inter-vehicle distance setting operator 54 is operated by the driver. The driver sets a set inter-vehicle distance Dset used for the autonomous traveling control described later by operating the inter-vehicle distance setting operator 54.

In this embodiment, the driver sets any one of a relatively long distance, a medium distance, and a relatively short distance as the set inter-vehicle distance Dset by operating the inter-vehicle distance setting operator 54. When the relatively long distance is set as the set inter-vehicle distance Dset, a relatively long distance Dlong is set as the set inter-vehicle distance Dset. When the medium distance is set as the set inter-vehicle distance Dset, a medium distance Dmid is set as the set inter-vehicle distance Dset. When the relatively short distance is set as the set inter-vehicle distance Dset, a relatively short distance Dshort is set.

The set inter-vehicle distance Dset is set to a longer distance as the host vehicle speed V1 is higher. It should be noted that, when the host vehicle speed V1 is the same, the relatively long distance Dlong is longer than the medium distance Dmid. Also, when the host vehicle speed V1 is the same, the medium distance Dmid is longer than the relatively short distance Dshort.

The inter-vehicle distance control width setting operator 55 is operated by the driver. The driver sets a set inter-vehicle distance control width WDset by operating the inter-vehicle distance control width setting operator 55. The set inter-vehicle distance control width WDset is used to set a target inter-vehicle distance control width WDtgt used for the autonomous driving control described later.

The vehicle speed detection device 61 is used for detecting the host vehicle speed V1. The vehicle speed detection device 61 includes, for example, wheel rotation speed sensors provided on respective wheels of the host vehicle 100. The vehicle speed detection device 61 is electrically connected to the ECU 90. The vehicle driving assistance apparatus 10 acquires the host vehicle speed V1 by means of the vehicle speed detection device 61.

The acceleration rate sensor 62 is used for detecting an acceleration rate G. The acceleration rate G is an acceleration rate in a longitudinal direction of the host vehicle 100. The acceleration rate sensor 62 is electrically connected to the ECU 90. The vehicle driving assistance apparatus 10 acquires the acceleration rate G by means of the acceleration rate sensor 62.

The gradient sensor 63 is used for detecting a road gradient θ. The road gradient θ is a gradient of a road on which the host vehicle 100 is currently traveling. The gradient sensor 63 is electrically connected to the ECU 90. The vehicle driving assistance apparatus 10 acquires the road gradient θ by means of the gradient sensor 63.

The surrounding information acquisition device 70 is used for detecting information on the surroundings of the host vehicle 100. In this embodiment, the surrounding information acquisition device 70 includes a plurality of electromagnetic wave sensors 71 and a plurality of image sensors 72.

The electromagnetic wave sensors 71 are electrically connected to the ECU 90. The electromagnetic wave sensors 71 are, for example, radar sensors such as millimeter-wave radars. The vehicle driving assistance apparatus 10 acquires information on objects existing around the host vehicle 100 (object information IO) as surrounding information IS by means of the electromagnetic wave sensors 71. In particular, the object information IO includes information on a preceding vehicle 200.

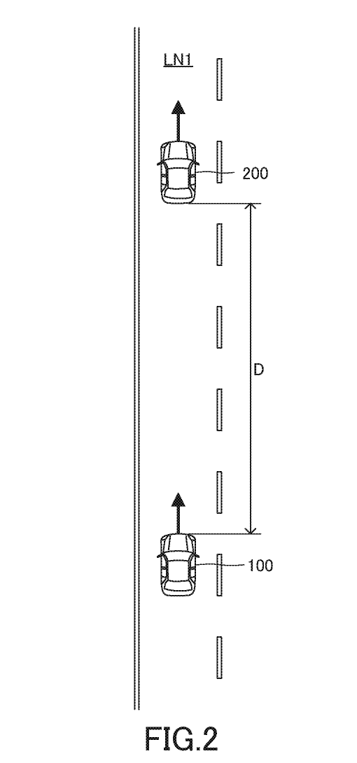

As shown in FIG. 2, the preceding vehicle 200 is another vehicle which is traveling on a host vehicle traveling lane LN1 ahead of the host vehicle 100 and exists within a predetermined distance Dth ahead of the host vehicle 100. The host vehicle traveling lane LN1 is a lane on which the host vehicle 100 is traveling. The preceding vehicle 200 is detected based on the surrounding information IS.

The image sensors 72 are electrically connected to the ECU 90. The image sensors 72 are, for example, camera sensors. The vehicle driving assistance apparatus 10 acquires image information IC on the surroundings of the host vehicle 100 as the surrounding information IS by means of the image sensors 72. In particular, the image information IC includes information on the preceding vehicle 200.

The GPS signal receiver 81 receives GPS signals. The GPS signal receiver 81 is electrically connected to the ECU 90. The vehicle driving assistance apparatus 10 receives GPS signals via the GPS signal receiver 81. The vehicle driving assistance apparatus 10 acquires a current position of the host vehicle 100 based on the GPS signal.

The map database 82 stores map information IM. The map database 82 is electrically connected to the ECU 90. The vehicle driving assistance apparatus 10 acquires road information IR from the current position of the host vehicle 100 and the map information IM. The road information IR is information relating to a road on which the host vehicle 100 is traveling. In particular, the road information IR includes information as to whether the road on which the host vehicle 100 is traveling is an expressway or a highway or is an ordinary road.

### Operation of Vehicle Driving Assistance Apparatus

Next, operation of the vehicle driving assistance apparatus 10 will be described.

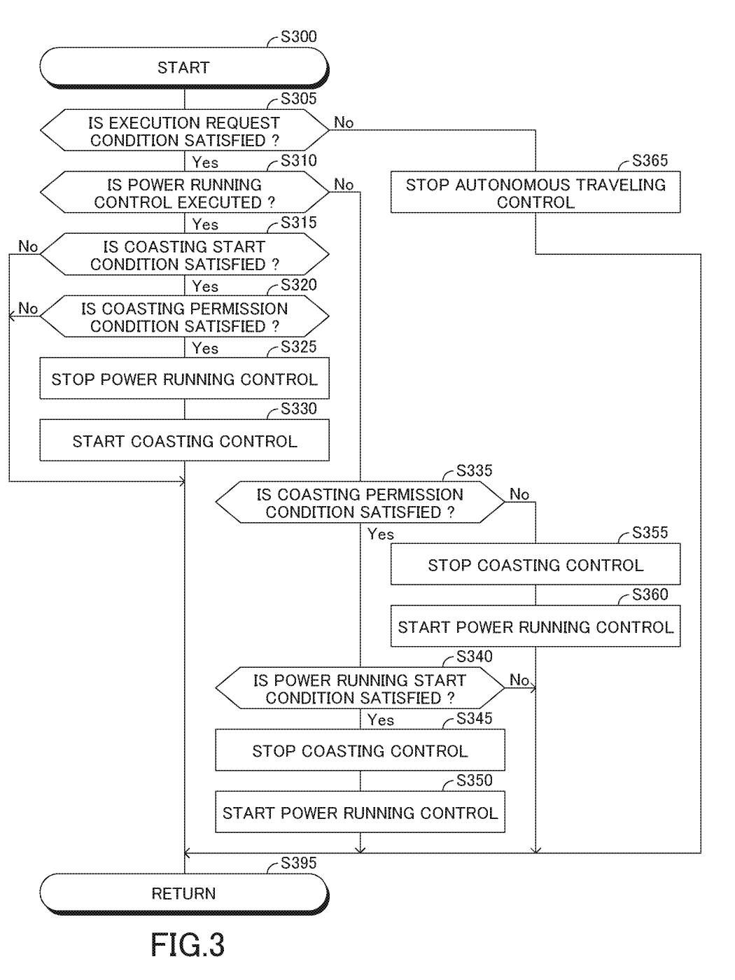

The vehicle driving assistance apparatus 10 executes the autonomous traveling control when predetermined conditions are satisfied by executing the routines shown in FIG. 3 to FIG. 5 at predetermined time intervals. The autonomous traveling control is a control of autonomously driving the host vehicle 100 by switching between a power running control and a coasting control.

The power running control is a control of causing the host vehicle 100 to perform power running. The vehicle driving assistance apparatus 10 causes the host vehicle 100 to perform power running by applying the driving force from the driving apparatus 20 to the host vehicle 100 during execution of the power running control. It should be noted that an optimum power running control may be adopted as the power running control. The optimum power running control is a control of causing the host vehicle 100 to perform power running by applying the driving force from the driving apparatus 20 to the host vehicle 100 while controlling operation of the driving apparatus 20 such that the driving energy efficiency becomes the highest. The driving energy efficiency is an energy efficiency at the time when the driving apparatus 20 generates the driving force.

It should be noted that, in this embodiment, the vehicle driving assistance apparatus 10, in principle, controls operation of the driving apparatus 20 such that the host vehicle 100 is accelerated during execution of the power running control.

The coasting control is a control of causing the host vehicle 100 to perform coasting. The vehicle driving assistance apparatus 10 causes the host vehicle 100 to perform coasting by stopping application of the driving force from the driving apparatus 20 to the host vehicle 100 during execution of the coasting control. In this embodiment, the vehicle driving assistance apparatus 10 stops application of the driving force from the driving apparatus 20 to the host vehicle 100 by cutting off the driving force transmission path during execution of the coasting control. As described above, the driving force transmission path is a path for applying the driving force from the driving apparatus 20 to the host vehicle 100. The vehicle driving assistance apparatus 10 cuts off the driving force transmission path by controlling operation of the driving force transmission device 40.

As described above, the vehicle driving assistance apparatus 10 executes the autonomous traveling control of autonomously driving the host vehicle 100 while alternately switching between the power running control of causing the host vehicle 100 to perform power running and the coasting control of causing the host vehicle 100 to perform coasting.

Also, the autonomous traveling control includes an autonomous vehicle speed control and an autonomous inter-vehicle distance control.

When a preceding vehicle 200 exists as shown in FIG. 2, the vehicle driving assistance apparatus 10 executes the autonomous inter-vehicle distance control as the autonomous traveling control. On the other hand, when no preceding vehicle 200 exists, the vehicle driving assistance apparatus 10 executes the autonomous vehicle speed control as the autonomous traveling control.

The autonomous vehicle speed control is a control of autonomously driving the host vehicle 100 by alternately repeating the power running control and the coasting control such that the host vehicle speed V1 is maintained at a speed within a target vehicle speed range RVtgt.

While the vehicle driving assistance apparatus 10 executes the autonomous vehicle speed control, the vehicle driving assistance apparatus 10 terminates the power running control and starts the coasting control when the host vehicle speed V1 increases and reaches a target upper limit speed Vtgt_max by the power running control. The target upper limit speed Vtgt_max is an upper limit value of the target vehicle speed range RVtgt. In this embodiment, the set vehicle speed Vset is set as the target upper limit speed Vtgt_max (Vtgt_max = Vset).

On the other hand, while the vehicle driving assistance apparatus 10 executes the autonomous vehicle speed control, the vehicle driving assistance apparatus 10 terminates the coasting control and starts the power running control when the host vehicle speed V1 decreases and reaches a target lower limit speed Vtgt_min by the coasting control. The target lower limit speed Vtgt_min is a lower limit value of the target vehicle speed range RVtgt. The target lower limit speed Vtgt_min is a speed obtained by subtracting the target vehicle speed control width WVtgt from the set vehicle speed Vset.

As described above, the vehicle driving assistance apparatus 10 switches between the power running control and the coasting control such that the host vehicle speed V1 falls within the speed of the target vehicle speed range RVtgt.

The autonomous inter-vehicle distance control is a control of autonomously driving the host vehicle 100 by autonomously alternately repeating the power running control and the coasting control such that an inter-vehicle distance D is maintained within a distance of a target inter-vehicle distance range RDtgt. The inter-vehicle distance D is a distance between the host vehicle 100 and the preceding vehicle 200. The inter-vehicle distance D is acquired based on the surrounding information IS.

While the vehicle driving assistance apparatus 10 executes the autonomous inter-vehicle distance control, the vehicle driving assistance apparatus 10 terminates the power running control and starts the coasting control when the inter-vehicle distance D shortens and reaches a target lower limit inter-vehicle distance Dtgt_min by the power running control. The target lower limit inter-vehicle distance Dtgt_min is a lower limit value of the target inter-vehicle distance range RDtgt. In this embodiment, the set inter-vehicle distance Dset is set as the target lower limit inter-vehicle distance Dtgt_min (Dtgt_min = Dset).

On the other hand, while the vehicle driving assistance apparatus 10 executes the autonomous inter-vehicle distance control, the vehicle driving assistance apparatus 10 terminates the coasting control and starts the power running control when the inter-vehicle distance D lengthens and reaches a target upper limit inter-vehicle distance Dtgt_max by the coasting control. The target upper limit inter-vehicle distance Dtgt_max is an upper limit value of the target inter-vehicle distance range RDtgt. In this embodiment, a value obtained by adding the target inter-vehicle distance control width WDtgt to the target lower limit inter-vehicle distance Dtgt_min is set as the target upper limit inter-vehicle distance Dtgt_max (Dtgt_max = Dtgt_min + WDtgt).

As described above, the vehicle driving assistance apparatus 10 switches between the power running control and the coasting control such that the inter-vehicle distance D falls within the distance of the target inter-vehicle distance range RDtgt.

It should be noted that, while the power running control is executed, when the host vehicle speed V1 reaches the target upper limit speed Vtgt_max before the inter-vehicle distance D reaches the target lower limit inter-vehicle distance Dtgt_min, the power running control is continued such that the host vehicle speed V1 is maintained at the target upper limit speed Vtgt_max. Also, while the coasting control is executed, when the host vehicle speed V1 reaches the target lower limit speed Vtgt_min before the inter-vehicle distance D reaches the target upper limit inter-vehicle distance Dtgt_max, the coasting control is terminated, and the power running control is executed such that the host vehicle speed V1 is maintained at the target lower limit speed Vtgt_min.

Therefore, it can be said that the autonomous inter-vehicle distance control is also a control of autonomously driving the host vehicle 100 by alternately repeating the power running control and the coasting control such that the host vehicle speed V1 is maintained at a speed within a range between the target upper limit speed Vtgt_max and the target lower limit speed Vtgt_min.

At a predetermined timing, the vehicle driving assistance apparatus 10 starts a process from a step S300 of the routine shown in FIG. 3. Then, the vehicle driving assistance apparatus 10 proceeds with the process to a step S305 to determine whether or not an execution request condition C1 is satisfied.

The execution request condition C1 is satisfied when execution of the autonomous traveling control is requested.

When the execution request condition C1 is satisfied, the vehicle driving assistance apparatus 10 determines “Yes” at the step S305 and proceeds with the process to a step S310 to determine whether or not the power running control is being executed.

When the power running control is being executed, the vehicle driving assistance apparatus 10 determines “Yes” at the step S310 and proceed with the process to a step S315 to determine whether or not a coasting start condition C2 is satisfied.

The coasting start condition C2 is satisfied when the host vehicle speed V1 rises and reaches the target upper limit speed Vtgt_max in a situation where the preceding vehicle 200 does not exist. On the other hand, in a situation where the preceding vehicle 200 exists, the coasting start condition C2 is satisfied when the inter-vehicle distance D shortens and reaches the target lower limit inter-vehicle distance Dtgt_min.

When the coasting start condition C2 is not satisfied, the vehicle driving assistance apparatus 10 determines “No” at the step S315 and proceeds with the process directly to a step S395 to terminate the process of this routine once. In this case, the power running control is continued. On the other hand, when the coasting start condition C2 is satisfied, the vehicle driving assistance apparatus 10 determines “Yes” at the step S315 and proceeds with the process to a step S320 to determine whether or not a coasting permission condition C3 is satisfied.

In a situation where the power running control is being executed, the coasting permission condition C3 is satisfied when a predicted deceleration rate Gd_p is equal to or smaller than a predetermined deceleration rate threshold Gd_th. On the other hand, , in a situation where the coasting control is being executed, the coasting permission condition C3 is satisfied when a detected deceleration rate Gd_d is equal to or smaller than the predetermined deceleration rate threshold Gd_th.

The predicted deceleration rate Gd_p is a deceleration rate of the host vehicle 100 predicted to occur when the power running control is switched to the coasting control at the present time. The vehicle driving assistance apparatus 10 predicts a deceleration rate of the host vehicle 100 based on the current host vehicle speed V1 the road gradient θ, etc., and acquires the predicted deceleration rate as the predicted deceleration rate Gd_p. As described above, during execution of the power running control, the vehicle driving assistance apparatus 10 predicts the deceleration rate of the host vehicle 100 in a case where the power running control is switched to the coasting control.

Also, the detected deceleration rate Gd_d is a current deceleration rate of the host vehicle 100. When the acceleration rate G detected by means of the acceleration rate sensor 62 is smaller than zero, the vehicle driving assistance apparatus 10 acquires an absolute value of the detected acceleration rate G as the detected deceleration rate Gd_d.

At a time when the vehicle driving assistance apparatus 10 has proceeded with the process to the step S320, the power running control is being executed. Therefore, the coasting permission condition C3 is satisfied when the predicted deceleration rate Gd_p is equal to or smaller than the predetermined deceleration rate threshold Gd_th.

When the coasting permission condition C3 is not satisfied, the vehicle driving assistance apparatus 10 determines “No” at the step S320 and proceeds with the process directly to the step S395 to terminate the process of this routine once. In this case, the power running control is continued.

As described above, when the deceleration rate of the host vehicle 100 by the coasting control (that is, the predicted deceleration rate Gd_p) is greater than the predetermined deceleration rate threshold Gd_th, the vehicle driving assistance apparatus 10 does not execute the coasting control. In other words, when the predicted deceleration rate (that is, the predicted deceleration rate Gd_p) is greater than the predetermined deceleration rate threshold Gd_th, the vehicle driving assistance apparatus 10 prohibits switching the power running control to the coasting control.

On the other hand, when the coasting permission condition C3 is satisfied, the vehicle driving assistance apparatus 10 determines “Yes” at the step S320 and proceeds with the process to a step S325 to stop the power running control. Next, the vehicle driving assistance apparatus 10 proceeds with the process to a step S330 to start the coasting control. Next, the vehicle driving assistance apparatus 10 proceeds with the process to the step S395 to terminate the process of this routine once.

As described above, when the predicted deceleration rate (that is, the predicted deceleration rate Gd_p) is equal to or smaller than the predetermined deceleration rate threshold Gd_th, the vehicle driving assistance apparatus 10 permits switching the power running control to the coasting control.

Also, when the vehicle driving assistance apparatus 10 is executing the coasting control at a time when the process has proceeded to the step S310, the vehicle driving assistance apparatus 10 determines “No” at the step S310 and proceeds with the process to a step S335 to determine whether or not the coasting permission condition C3 is satisfied.

At a time when the vehicle driving assistance apparatus 10 has proceeded with the process to the step S335, the coasting control is being executed. Therefore, the coasting permission condition C3 is satisfied when the detected deceleration rate Gd_d is equal to or smaller than the predetermined deceleration rate threshold Gd_th.

When the coasting permission condition C3 is satisfied, the vehicle driving assistance apparatus 10 determines “Yes” at the step S335 and proceeds with the process to a step S340 to determine whether or not a power running start condition C4 is satisfied.

In a situation where the preceding vehicle 200 does not exist, the power running start condition C4 is satisfied when the host vehicle speed V1 decreases and reaches the target lower limit speed Vtgt_min. On the other hand, in a situation where the preceding vehicle 200 exists, the power running start condition C4 is satisfied when the inter-vehicle distance D lengthens and reaches the target upper limit inter-vehicle distance Dtgt_max.

When the power running start condition C4 is not satisfied, the vehicle driving assistance apparatus 10 determines “No” at the step S340 and proceeds with the process directly to the step S395 to terminate the process of this routine once. In this case, the coasting control is continued. On the other hand, when the power running start condition C4 is satisfied, the vehicle driving assistance apparatus 10 determines “Yes” at the step S340 and proceeds with the process to a step S345 to stop the coasting control. Next, the vehicle driving assistance apparatus 10 proceeds with the process to a step S350 to start the power running control. Next, the vehicle driving assistance apparatus 10 proceeds with the process to the step S395 to terminate the process of this routine once.

Also, when the coasting permission condition C3 is not satisfied at a time when the vehicle driving assistance apparatus 10 has proceeded with the process to the step S335, the vehicle driving assistance apparatus 10 determines “No” at the step S335 and proceeds with the process to a step S355 to stop the coasting control. Next, the vehicle driving assistance apparatus 10 proceeds with the process to a step S360 to start the power running control.

As described above, when the deceleration rate of the host vehicle 100 by the coasting control (that is, the detected deceleration rate Gd_d) is greater than the predetermined deceleration rate threshold Gd_th, the vehicle driving assistance apparatus 10 does not execute the coasting control. In other words, when the deceleration rate of the host vehicle 100 becomes greater than the predetermined deceleration rate threshold Gd_th during execution of the coasting control, the vehicle driving assistance apparatus 10 stops the coasting control.

Next, the vehicle driving assistance apparatus 10 proceeds with the process to the step S395 to terminate the process of this routine once.

It should be noted that, when the vehicle driving assistance apparatus 10 is executing the autonomous vehicle speed control when starting the power running control at the step S360, the vehicle driving assistance apparatus 10 may be configured to execute the power running control such that the host vehicle speed V1 at that time is maintained. Also, when the vehicle driving assistance apparatus 10 is executing the autonomous inter-vehicle distance control at a time when starting the power running control at the step S360, the vehicle driving assistance apparatus 10 may be configured to execute the power running control such that the inter-vehicle distance D at that time is maintained.

Also, when the execution request condition C1 is not satisfied at a time when the vehicle driving assistance apparatus 10 has proceeded with the process to the step S305, the vehicle driving assistance apparatus 10 determines “No” at the step S305 and proceeds with the process to a step S365. When the vehicle driving assistance apparatus 10 is executing the autonomous traveling control at a time when the process has proceeded to the step S365, the vehicle driving assistance apparatus 10 stops the autonomous traveling control. Next, the vehicle driving assistance apparatus 10 proceeds with the process to the step S395 to terminate the process of this routine once.

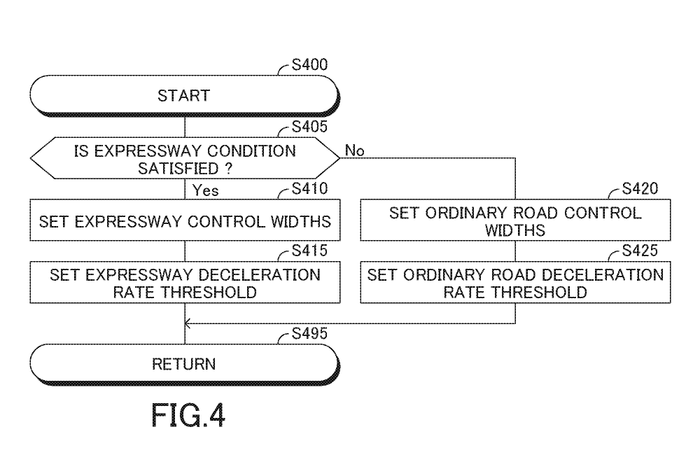

Further, at a predetermined timing, the vehicle driving assistance apparatus 10 starts a process from a step S400 of the routine shown in FIG. 4. Then, the vehicle driving assistance apparatus 10 proceeds with the process to a step S405 to determine whether or not an expressway condition C5 is satisfied.

The expressway condition C5 is satisfied when the host vehicle 100 is traveling on an expressway or a highway. On the other hand, the expressway condition C5 is not satisfied when the host vehicle 100 is traveling on neither an expressway nor a highway. For example, the expressway condition C5 is not satisfied when the host vehicle 100 is traveling on an ordinary road. The vehicle driving assistance apparatus 10 determines whether or not the host vehicle 100 is traveling on an expressway or a highway based on the road information IR.

When the expressway condition C5 is satisfied, the vehicle driving assistance apparatus 10 determines “Yes” at the step S405 and proceeds with the process to a step S410. On the other hand, when the expressway condition C5 is not satisfied, the vehicle driving assistance apparatus 10 determines “No” at the step S405 and proceeds with the process to a step S420.

When the vehicle driving assistance apparatus 10 proceeds with the process to the step S410, the vehicle driving assistance apparatus 10 sets an expressway vehicle speed control width WVh as the target vehicle speed control width WVtgt and sets an expressway inter-vehicle distance control width WDh as the target inter-vehicle distance control width WDtgt. Next, the vehicle driving assistance apparatus 10 proceeds with the process to a step S415 to set an expressway deceleration rate threshold Gd_h as the predetermined deceleration rate threshold Gd_th. Next, the vehicle driving assistance apparatus 10 proceeds with the process to a step S495 to terminate the process of this routine once.

It should be noted that, in this embodiment, the set vehicle speed control width WVset is set as the expressway vehicle speed control width WVh. Also, the set inter-vehicle distance control width WDset is set as the expressway inter-vehicle distance control width WDh.

On the other hand, when the vehicle driving assistance apparatus 10 proceeds with the process to the step S420, the vehicle driving assistance apparatus 10 sets an ordinary road vehicle speed control width WVs as the target vehicle speed control width WVtgt and sets an ordinary road inter-vehicle distance control width WDs as the target inter-vehicle distance control width WDtgt.

In this embodiment, the ordinary road vehicle speed control width WVs is set to a value smaller than the expressway vehicle speed control width WVh. Therefore, when the host vehicle 100 is traveling on an ordinary road, the vehicle driving assistance apparatus 10 sets, as the target vehicle speed control width WVtgt, the ordinary road vehicle speed control width WVs which is smaller than the set vehicle speed control width WVset set by the driver.

Also, the ordinary road inter-vehicle distance control width WDs is set to a value smaller than the expressway inter-vehicle distance control width WDh. Therefore, when the host vehicle 100 is traveling on an ordinary road, the vehicle driving assistance apparatus 10 sets, as the target inter-vehicle distance control width WDtgt, the ordinary road inter-vehicle distance control width WDs which is smaller than the set inter-vehicle distance control width WDset set by the driver.

Therefore, when the host vehicle 100 is traveling on an ordinary road, as compared with when the host vehicle 100 is traveling on an expressway or a highway, the host vehicle 100 is caused to travel by the autonomous traveling control within a narrower target vehicle speed range RVtgt or a narrower target inter-vehicle distance range RDtgt.

As described above, when the road on which the host vehicle 100 is traveling is an ordinary road, the vehicle driving assistance apparatus 10 sets the target vehicle speed control width WVtgt and the target inter-vehicle distance control width WDtgt to smaller values as compared with when the road on which the host vehicle 100 is traveling is an expressway or a highway. Therefore, when the road on which the host vehicle 100 is traveling is an ordinary road, the vehicle driving assistance apparatus 10 narrows the target vehicle speed range RVtgt and the target inter-vehicle distance range RDtgt as compared with when the road on which the host vehicle 100 is traveling is an expressway or a highway.

It should be noted that, although the ordinary road vehicle speed control width WVs is set to a value smaller than the expressway vehicle speed control width WVh, the ordinary road vehicle speed control width WVs is set to a value greater than zero. Similarly, although the ordinary road inter-vehicle distance control width WDs is set to a value smaller than the expressway inter-vehicle distance control width WDh, the ordinary road inter-vehicle distance control width WDs is set to a value greater than zero.

Next, the vehicle driving assistance apparatus 10 proceeds with the process to a step S425 to set an ordinary road deceleration rate threshold Gd_s as the predetermined deceleration rate threshold Gd_th.

In this embodiment, the expressway deceleration rate threshold Gd_h is set to a value greater than the ordinary road deceleration rate threshold Gd_s. Therefore, when the host vehicle 100 is traveling on an ordinary road, as compared with when the host vehicle 100 is traveling on an expressway or a highway, the host vehicle 100 is caused to travel by the autonomous traveling control within a range of a smaller deceleration rate.

As described above, when the road on which the host vehicle 100 is traveling is an ordinary road, the vehicle driving assistance apparatus 10 sets the predetermined deceleration rate threshold Gd_th to a smaller value as compared with when the road on which the host vehicle 100 is traveling is an expressway or a highway.

It should be noted that, although the ordinary road deceleration rate threshold Gd_s is set to a value smaller than the expressway deceleration rate threshold Gd_h, the ordinary road deceleration rate threshold Gd_s is set to a value greater than zero.

Next, the vehicle driving assistance apparatus 10 proceeds with the process to the step S495 to terminate the process of this routine once.

The above is operation of the vehicle driving assistance apparatus 10.

According to the vehicle driving assistance apparatus 10, when the host vehicle 100 is traveling on an ordinary road, the target vehicle speed range RVtgt and the target inter-vehicle distance range RDtgt are made relatively narrow. Therefore, when the host vehicle 100 is caused to coast by the autonomous traveling control, it is suppressed that the host vehicle speed V1 becomes excessively low or that an increase or a decrease of the host vehicle speed V1 becomes excessively large. For this reason, when the host vehicle 100 is traveling on an ordinary road, the host vehicle 100 can be appropriately caused to coast.

It should be noted that the present invention is not limited to the above-described embodiment, and various modifications can be adopted within the scope of the present invention.

What is claimed is:

1. A vehicle driving assistance apparatus comprising an electronic control unit which executes an autonomous traveling control of autonomously driving a host vehicle while alternately switching between a power running control of causing the host vehicle to perform power running and a coasting control of causing the host vehicle to perform coasting,
wherein the electronic control unit is configured to:
switch between the power running control and the coasting control such that a traveling speed of the host vehicle falls within a speed of a predetermined range or an inter-vehicle distance between the host vehicle and a preceding vehicle falls within a distance of a predetermined range; and
narrow the predetermined range when a road on which the host vehicle is traveling is an ordinary road as compared with when the road on which the host vehicle is traveling is an expressway or a highway.

2. The vehicle driving assistance apparatus according to claim 1, wherein the electronic control unit is configured to avoid executing the coasting control when a deceleration rate of the host vehicle by the coasting control is greater than a predetermined deceleration rate threshold.

3. The vehicle driving assistance apparatus according to claim 2, wherein the electronic control unit is configured to set the predetermined deceleration rate threshold to a smaller value when a road on which the host vehicle is traveling is the ordinary road as compared with when the road on which the host vehicle is traveling is the expressway or the highway.

4. The vehicle driving assistance apparatus according to claim 1,
wherein the electronic control unit is configured to:
predict a deceleration rate of the host vehicle in a case where the power running control being executed is switched to the coasting control;
set the predetermined deceleration rate threshold to a smaller value when the road on which the host vehicle is traveling is the ordinary road as compared with when the road on which the host vehicle is traveling is the expressway or the highway;
permit switching the power running control to the coasting control when the predicted deceleration rate is equal to or smaller than the predetermined deceleration rate threshold; and
prohibit switching the power running control to the coasting control when the predicted deceleration rate is greater than the predetermined deceleration rate threshold.

5. The vehicle driving assistance apparatus according to claim 1,
wherein the electronic control unit is configured to:
set the predetermined deceleration rate threshold to a smaller value when the road on which the host vehicle is traveling is the ordinary road as compared with when the road on which the host vehicle is traveling is the expressway or the highway; and
stop the coasting control when a deceleration rate of the host vehicle becomes greater than the predetermined deceleration rate threshold during execution of the coasting control.
